(19) United States
(12) Patent Application Publication
(10) Pub. No.: US 2016/0012539 A1
(43) Pub. Date: Jan. 14, 2016

(54) MOBILE TOTAL LOSS VEHICLE EVALUATION SYSTEM

(71) Applicant: Sergey Gorelov, West Linn, OR (US)

(72) Inventor: Sergey Gorelov, West Linn, OR (US)

(73) Assignee: Audatex North America, Inc., San Diego, CA (US)

(21) Appl. No.: 14/328,544

(22) Filed: Jul. 10, 2014

(51) Int. Cl. G06Q 40/08; G06Q 30/02

(52) U.S. Cl. CPC G06Q 40/08; G06Q 30/0278

(57) ABSTRACT

An apparatus and method for generating a total loss valuation for a damaged vehicle that has a VIN code that represents a VIN of the damaged vehicle. The VIN code is scanned with a mobile device to capture the VIN. The VIN is transferred to a server that decodes the VIN to determine vehicle information. The vehicle information is transferred back to the mobile device which populates an insurance claim view with the information. User entered vehicle information is captured by the mobile device. The vehicle information and the user entered vehicle information are transferred to the server which generates a total loss valuation from the information. The total loss valuation is transferred to the mobile device which displays the total loss value.

### BACKGROUND OF THE INVENTION

1. Field of the Invention

The subject matter disclosed generally relates to a method and system for obtaining a total loss valuation for a damaged vehicle.

2. Background Information

When a vehicle such as an automobile is damaged the owner may file a claim with an insurance carrier. A claims adjuster typically inspects the vehicle to determine the amount of damage and the costs required to repair the automobile. The owner of the vehicle or the vehicle repair facility may receive a check equal to the estimated cost of the repairs. If the repair costs exceed the value of the automobile, or a percentage of the car value, the adjuster may “total” the vehicle. The owner may then receive a check equal to the value of the automobile.

The repair costs and other information may be entered by the adjuster into an estimate report. After inspection the adjuster sends the estimate report to a home office for approval. To improve the efficiency of the claims process there have been developed computer systems and accompanying software that automate the estimate process. By way of example, the assignee of the present invention, Audatex, Inc., (“Audatex”) provides a software product under the trademark Audatex Estimating that allows a claims adjuster to enter estimate data. The data includes a list of damaged parts. The parts can be selected by entering text describing the part(s) or by selection of a graphical depiction of the vehicle part(s) The Estimating product includes a database that provides the cost of the selected parts and the labor cost associated with repairing the parts.

Audatex also provides a product under the trademark Autosource that allows a user to obtain a total loss valuation for the vehicle. The Autosource product requires the entry of vehicle information such as the vehicle identification number (VIN), vehicle options, etc. This information is manually entered and is thus susceptible to error. It would be desirable to improve the accuracy and efficiency of obtaining a total loss valuation for an insurance claim.

### BRIEF SUMMARY OF THE INVENTION

An apparatus and method for generating a total loss valuation for a damaged vehicle that has a VIN code that represents a VIN of the damaged vehicle. The VIN code is scanned with a mobile device to capture the VIN. The VIN is transferred to a server that decodes the VIN to determine vehicle information. The vehicle information is transferred back to the mobile device which populates an insurance claim view with the information. User entered vehicle information is captured by the mobile device. The vehicle information and the user entered vehicle information are transferred to the server which generates a total loss valuation from the information. The total loss valuation is transferred to the mobile device which displays the total loss value.

### BRIEF DESCRIPTION OF THE DRAWINGS

FIG. 1 is a schematic of a network system that can be used to generate a total loss valuation for damaged vehicle;

FIG. 2 is a schematic of a mobile device of the system; and,

FIGS. 3A-N are illustrations of graphical user interfaces displayed by the mobile device.

### DETAILED DESCRIPTION

Disclosed is an apparatus and method for generating a total loss valuation for a damaged vehicle that has a VIN code that represents a VIN of the damaged vehicle. The VIN code is scanned with a mobile device to capture and read the VIN. The VIN code can be a bar code, QR code or any other type of code that can be scanned by a mobile device. The VIN is transferred to a server that decodes the VIN to determine vehicle information. The vehicle information is transferred back to the mobile device which populates an insurance claim view with the information. User entered vehicle information is captured by the mobile device. The vehicle information and the user entered vehicle information are transferred to the server which generates a total loss valuation from the information. The total loss valuation is transferred to the mobile device which displays the total loss value. The system can be utilized by users such as insurance adjusters to obtain a total loss value of the vehicle. Deriving vehicle information from the scanned VIN code reduces errors and improves the efficiency of obtaining a total loss value.

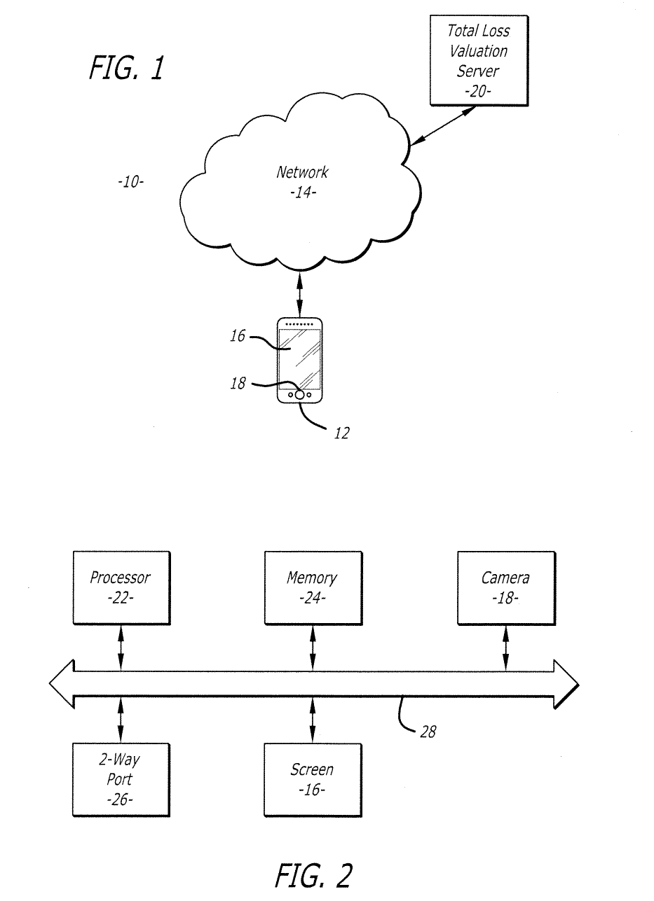

Referring to the drawings more particularly by reference numbers, FIG. 1 shows a system 10 that can be used to generate a total loss value for a damaged vehicle as part of an insurance claim. The system 10 includes at least one mobile device 12 that is connected to an electronic communication network(s) 14. The mobile device 12 may be cell phone, tablet or other hand held device. The mobile device 12 includes a screen 16 and a camera 18. The camera 18 may be used to scan a VIN code of a vehicle. The VIN code represents the vehicle VIN.

The system 10 may further include a total loss valuation server 20 connected to the network 14. The total loss valuation server 20 may receive vehicle information from the mobile device 12. The server 16 processes the information to generate a total loss valuation for the vehicle. By way of example, the server 20 may contain a database(s) and software the same or similar to the product Autosource provided by the assignee Audatex North America, Inc. The total loss valuation provides a market value for the vehicle that considers such factors as the year, make, model, condition and geographic location of the vehicle, along with aftermarket, options and equipment packages of the vehicle.

FIG. 2 shows an embodiment of the mobile device 12. The device 12 includes a processor 22 connected to one or more memory devices 24. The memory device 24 may include both volatile and non-volatile memory such as read only memory (ROM) or random access memory (RAM). The processor 22 is capable of operating software programs in accordance with instructions and data stored within the memory device 24.

The processor 40 may be coupled to the memory 24, camera 18, a screen 16 and a two-way communication port 26 thru bus 28. The communication. port 26 provides two-communication with the network. The screen 16 may include a touch function that allows a user to select options by touching a corresponding portion of the screen 16.

Without limiting the scope of the invention the term computer readable medium may include the memory device 12. The computer readable medium may contain software programs in binary form that can be read and interpreted by the processor 22.

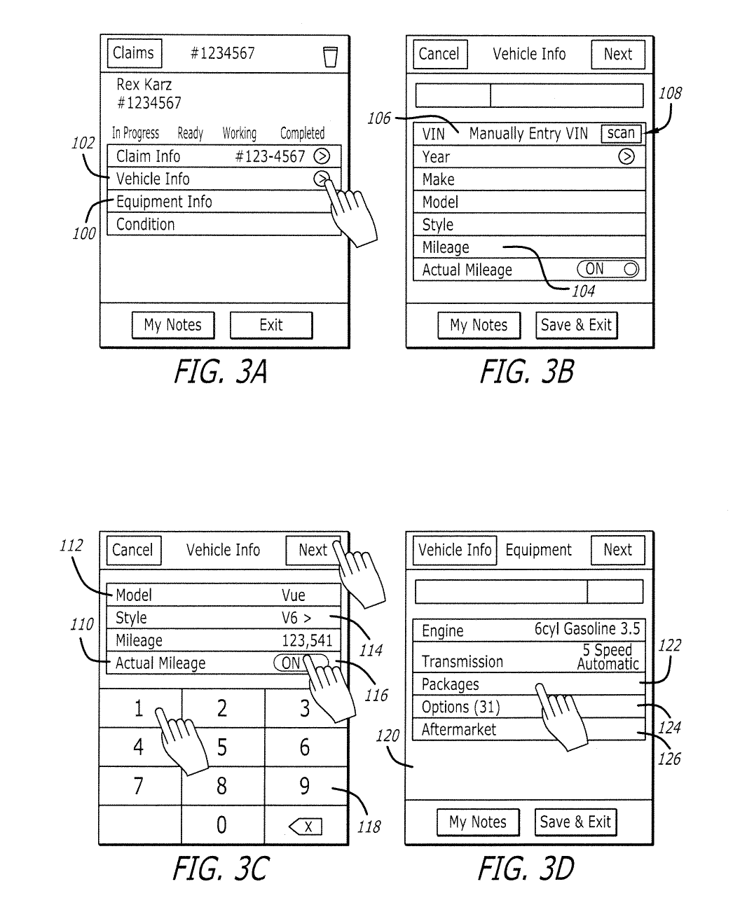

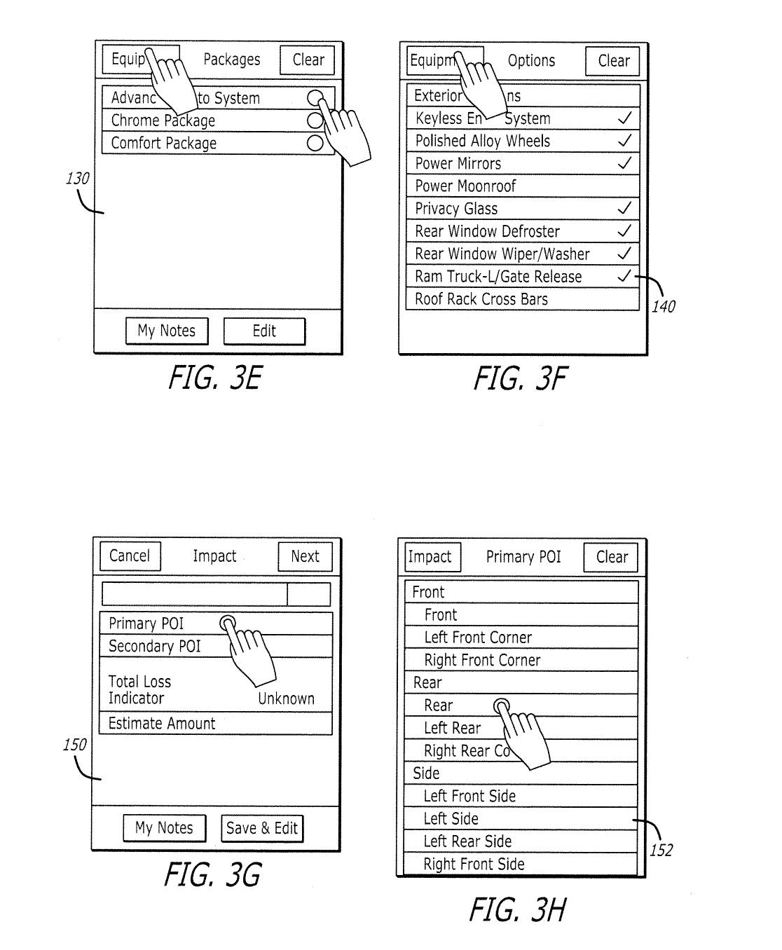

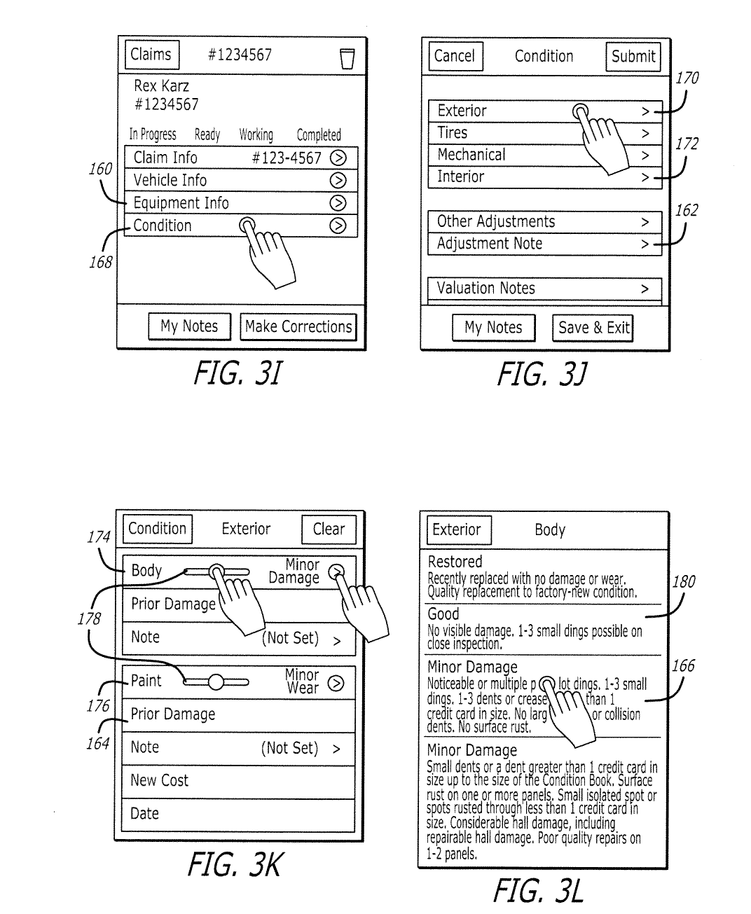

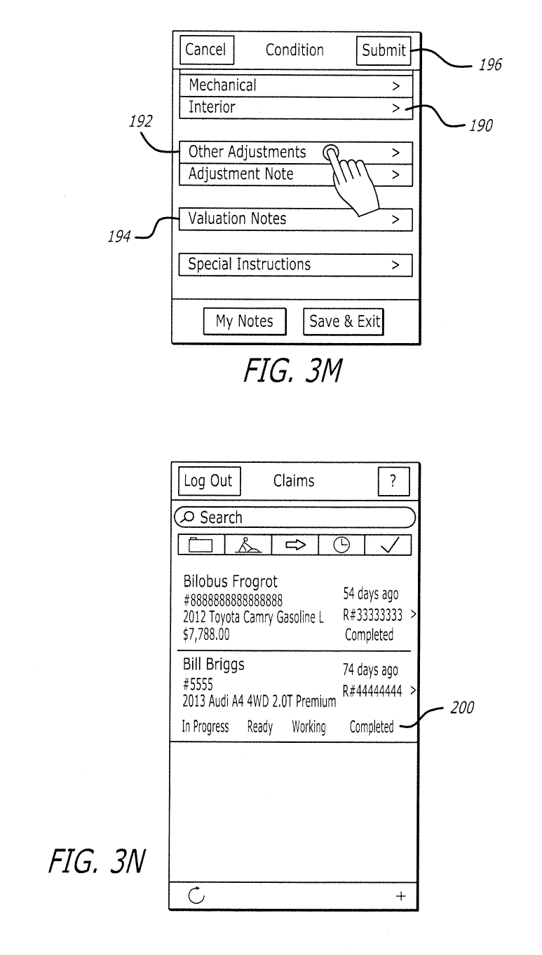

FIGS. 3A-N show graphical user interfaces (GUIs) that can be utilized by a user to obtain a total loss valuation. The user interfaces may include initial log on views (not shown) that allow access to the system. FIG. 3A shows an interface 100 with a VEHICLE INFO field 102 that can be selected. Selection of the VEHICLE INFO field 102 causes the display of the interface 104 shown in FIG. 3B. Interface 104 includes a VIN field 106 with a SCAN field 108. A vehicle VIN can be captured by selecting the SCAN field 108 and scanning the mobile device camera across the VIN code. The mobile device 12 translates the VIN code into a VIN. The VIN is then transferred to the server 16 which decodes the VIN and generates vehicle information that is sent back to the mobile device 12. The mobile device 12 then automatically populates certain fields with the vehicle information. FIG. 3C shows an interface 110 where the MODEL 112 and STYLE 114 fields of the vehicle have been auto-populated. This interface 110 also includes an ACTUAL MILEAGE field 116 that can be selected to display a graphical keypad 118 that allows the user to enter the mileage of the damaged vehicle.

FIG. 3D shows an interface 120 with PACKAGES 122, OPTIONS 124 and AFTERMARKET 126 fields. These fields can be selected to low the user to select packages, options or aftermarket features of the vehicle. FIG. 3E shows an interface 130 if the PACKAGE field 122 is selected. FIG. 3F shows an interface 140 if the OPTIONS field is selected. The interfaces 130 and 140 include further fields that can be selected to enter package and options features for the vehicle.

FIGS. 3G and 3H shows interfaces 150 and 152 with fields that allow the user to enter the area of the vehicle that is damaged. FIG. 3I, 3J, 3K and 3L show interfaces 160, 162, 164 and 166 can be used to enter condition information for the vehicle. Interface 160 includes a CONDITION field 168 that can be selected to display interface 162 shown in FIG. 3J. Interface 162 can include EXTERIOR 170 arid INTERIOR 172 fields. FIG. 3K shows the interface 164 when the EXTERIOR field 170 is selected. Interface 164 includes BODY 174 and PAINT 176 fields with graphical slide bars 178 that can be manipulated by the user to establish a rating for the condition of the vehicle body and paint. The fields 174 and 176 can be selected to cause the display of interface 166. Interface 166 includes various condition rating fields 180 that provide descriptions for different condition ratings. These fields 180 can be selected to enter condition information.

FIG. 3M shows an interface 190 with an OTHER ADJUSTMENTS field 192 and VALUATION NOTES field 194 that can be selected to allow the user to make further adjustments and notes to the vehicle information. For example, if the user is an inspector such as an insurance appraiser, the notes may include an identification of vehicle equipment, condition of the vehicle for the accident and expert opinions. The mobile device may also display an interface (not shown) that allows the user to attach a photo(s) or video of the damaged vehicle.

Interface 190 includes a SUBMIT field 196. Selection of the SUBMIT field 196 causes the information entered for the claim to he transmitted to the server. The server process the information to generate a total loss valuation that is transmitted to the mobile device. FIG. 3N shows an interface 200 that displays the total loss valuation for a vehicle. The valuation report can also be e-mailed to a third party, such as an insurance appraiser.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for generating a total loss valuation for a damaged vehicle that has a VIN code that represents a VIN of the damaged vehicle, comprising:
scanning the VIN code and capturing the VIN with a mobile device;
transferring the VIN to a server;
determining vehicle information by decoding the VIN;
transferring the vehicle information to the mobile device;
populating an insurance claim view displayed on the mobile device with the vehicle information;
capturing user entered vehicle information with the mobile device;
transferring the vehicle information and the user entered vehicle information to the server;
generating a total loss valuation from the vehicle information and the user entered vehicle information;
transferring the total loss valuation to the mobile device; and,
displaying the total loss valuation on the mobile device.

2. The method of claim 1, wherein the user entered vehicle information includes vehicle packages.

3. The method of claim 1, wherein the user entered vehicle information includes vehicle options.

4. The method of claim 1, wherein the user entered vehicle information includes conditions of the damaged vehicle.

5. The method of claim 4, further comprising displaying preselected vehicle conditions that can be selected by a user.

6. The method of claim 1, wherein the user entered vehicle information is entered by tapping on a screen of the mobile device.

7. The method of claim 1, wherein the mobile device is a cell phone.

8. A non-transitory computer program storage medium, comprising computer-readable instruct for generating a total loss valuation for a damaged vehicle that has a VIN code that represents a VIN of the damaged vehicle, execution of said computer-readable instructions by at least one processor of a mobile device performs the steps of:
scanning the VIN code and capturing the VIN with a mobile device;
transferring the VIN to a server;
receiving vehicle information that was determined by decoding the VIN;
populating an insurance claim view that is displayed b the mobile device with the vehicle information;
capturing user entered vehicle information;
transferring the vehicle information and user entered vehicle information to the server;
receiving a total loss valuation that was generated from the vehicle information and the user entered vehicle information; and,
displaying the total loss valuation on the mobile device.

9. The non-transitory computer program storage medium of claim 8, wherein the user entered vehicle information includes vehicle packages.

10. The non-transitory computer program storage medium of can 8, wherein the user entered vehicle information includes vehicle options.

11. The non-transitory computer program storage medium of claim 8, wherein the user entered vehicle information includes conditions of the damaged vehicle.

12. The non-transitory computer program storage medium of claim 11, further comprising displaying preselected vehicle conditions that can be selected by a user.

13. The non-transitory computer program storage medium of claim 8, wherein the user entered vehicle information is entered by tapping on a screen of the mobile device.

14. The non-transitory computer program storage medium of claim 8, wherein the mobile device is a cell phone.
